(19) United States
(12) Patent Application Publication
(10) Pub. No.: US 2024/0361048 A1
(43) Pub. Date: Oct. 31, 2024

(54) COOLING SYSTEM AND MACHINE FOR THE PRODUCTION OF ICE CREAMS COMPRISING SUCH SYSTEM

(71) Applicant: TOOA S.P.A., Fabriano (AN) (IT)

(72) Inventor: Marcello RIDERELLI BELLI, Osimo (AN) (IT)

(73) Assignee: TOOA S.P.A., Fabriano (AN) (IT)

(21) Appl. No.: 18/641,759

(22) Filed: Apr. 22, 2024

(30) Foreign Application Priority Data
Apr. 27, 2023 (IT) 102023000008244

(51) Int. Cl. F25B 21/02; A23G 9/22

(52) U.S. Cl. CPC F25B 21/02; A23G 9/22

(57) ABSTRACT

The cooling system (10′, 10″, 10^{III}) according to the invention, for a machine for processing a mixture comprises A) a central body (1′, 1″, 1^{III}); B) at least three Peltier cells (2) each of which resting on said external flanks of the central body; C) one or more heat sinks (3); D) an assembling system (5′) in turn comprising a belt element (51) and a tensioner (55). The tensioner (55) tensions the belt element (51) by tightening the three Peltier cells (2) against the external flanks of the central body (1′, 1″, 1^{III}) and fixing the at least three Peltier cells (2) to such flanks. The invention also relates to a machine for producing ice creams provided with such cooling system.

The present US application claims the priority of the Italian patent application no IT102023000008244 and incorporates the whole content thereof by reference.

### FIELD OF THE INVENTION

The present invention refers to a cooling system to be applied to machines, particularly in machines for food products or pharmaceutical/cosmetic/chemical products, even more particularly for the domestic production of food, for example a machine for producing single portions of ice cream, mousse, sorbets, creams, or still other food.

The invention also relates to a machine, particularly a machine for food use, provided with such cooling system.

The following description specifically refers to food machines, particularly for the production of ice cream, however, the Applicant specifies that such cooling system is not intended to be limited to the use in food machines but can be applied for cooling any type of cream or product.

### STATE OF THE ART

A cooling system particularly adapted to be applied to machines for producing single portions of ice cream, sorbet, mousse, or other cold food creams is known from Italian Patent Application No. IT102020000024817.

Such cooling system is extremely effective and capable of cooling in a homogeneous and almost immediate manner (maximum cooling rate higher than 1° C./sec) the ice cream being prepared or other food mixture, avoiding the creation of ice blocks and clumps, thus allowing single portions of ice cream to be prepared almost instantaneously and on demand.

Such cooling system is further compact, space-saving, extremely effective, and eco-friendly since it does not use refrigerant gases nor requires the cold chain.

The cooling system described in Patent Application No. IT102020000024817 comprises four Peltier cells 2 fixed on the external flanks of a central body made of aluminium 1—which forms the receptacle in which the ice cream is creamed-through two elements made of steel wire 51 and two respective tensioning metallic bars 52.

Each element made of steel wire 51 is approximately U- or C-shaped and its threaded ends pass through two holes formed on a respective bar 52.

By screwing them on such threaded ends, two respective threaded nuts 53 rest against the external face of the bar 52 and push it towards the bottom of the cavity formed by the steel wire 51 (FIG. 5 of Application No. IT102020000024817) by pushing against the external flanks of the central body 1 two thermoelectric modules—referred to as “Peltier cells” in the present description—2 located in positions diametrically opposite to each other (FIGS. 1, 2 of Application No. IT102020000024817).

The author of the present invention observed that such known fixing system allows only an even number of Peltier cells 2 to be mounted on the external flanks of the central body 1, and in the practice allows only two or four Peltier cells 2 to be mounted, actually making mounting for example six, eight, or a greater even number of them impossible or very disadvantageous.

Indeed, an assembly formed by a steel wire 51 and the relative bar 52 is capable of pushing against the main body 1 exactly two Peltier cells, not a different number.

In order to fix to the main body 1 multiple pairs of Peltier cells 2, the same number of steel wires 51 are to be mounted, inevitably overlapping each other in the direction of the central axis of the main body 1 itself.

As the number of overlapping wires 51 increases, some Peltier cells 2, due to the bulk of the various components, are pressed by the respective wire 51 in positions increasingly closer to the lower or upper edge of the cells themselves, causing undesired concentrations of pressure on the flanks of the central body 1 and by fixing the Peltier cells increasingly less firmly, and therefore limiting the maximum number to only four Peltier cells which in the practice can be mounted in a known cooling system 10 described in Application No. IT102020000024817.

Such maximum number is also limited, in reality, by the bulk of the different bars 52 as well as the rapid increase of the mounting time and the production costs of the known cooling system 50 as a function of the increasing number of pairs of wire 51+bar 52 mounted on the flanks of a main body 1.

Therefore, an object of the present invention is to provide a cooling system for producing ice cream or other alimentary pastes or more generally for processing a mixture, which allows to also fix a greater number, also odd, of Peltier cells on the flanks of a central body 1 in a mechanically easier, cheaper, quicker, and more efficient manner.

### SUMMARY OF THE INVENTION

These and other objects according to the present invention are achieved by making a cooling system as set forth in claim 1.

Further features of the system are the object of the dependent claims.

A further object of the present invention is to make a machine, particularly a machine for food use as set forth in claim 13.

The features and the advantages of a cooling system for machines for the production of ice creams according to the present invention will be more apparent from the following exemplary and non-limiting description, given with reference to the following attached schematic figures.

### LIST OF THE FIGURES

FIG. 1 shows a top perspective view of some components of a cooling system according to a first embodiment of the present invention;

FIG. 2 shows a top view of the cooling system of FIG. 1;

FIG. 3 shows a top perspective view of some components of a cooling system according to a second embodiment of the present invention;

FIG. 4 shows a top view of the cooling system of FIG. 2;

FIG. 5 shows a top perspective view of some components of a cooling system according to a third embodiment of the present invention;

FIG. 6 shows a top view of the cooling system of FIG. 5;

FIG. 7 shows is a perspective view of a cooling circuit associated to the systems of FIG. 1, 3 or 5;

FIG. 8 shows a bottom perspective view of the cooling system of FIG. 3;

FIG. 9 is a perspective view of the central body of the cooling system of FIG. 2;

FIG. 10 is a perspective view of a Peltier cell of the cooling system of FIG. 2.

### DETAILED DESCRIPTION

With reference to the attached figures, a cooling system, overall indicated by 10′, 10″, 10^{III}, is shown, particularly for use in a machine (not shown in the attached figures) for processing, thus cooling, a mixture, such as for example a food mixture for the production of ice cream.

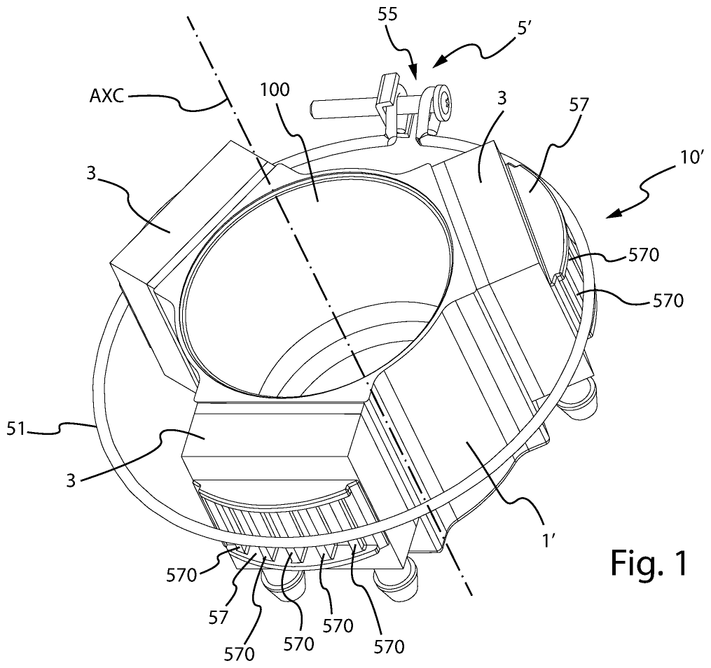

According to the present invention, as illustrated in FIGS. 1-6 the cooling system 10′, 10″, 10^{III} comprises a central body 1′, 1″, 1^{III} which in turn comprises a working cavity 100 suitable for housing the mixture and/or the products to be cooled, directly or through a further container.

The working cavity 100 defines an axis AXC which is the rotation axis around which a possible rotor—for example one or more blades or scrapers of a creaming machine-arranged in the cavity 100 rotates, and/or is the symmetrical axis of the cavity 100 if it has a substantially cylindrical or prismatic shape and/or the axis of the cone, truncated cone, pyramid, or truncated pyramid possibly formed by the working cavity 100 (FIG. 1).

The central body 1′, 1″, 1^{III} preferably forms external flanks extending substantially parallel or longitudinal to the axis AXC of the working cavity 100.

The central body 1′, 1″, 1^{III} is preferably made of a material having a high thermal conductivity such as for example aluminium, copper, steel, or other metallic material.

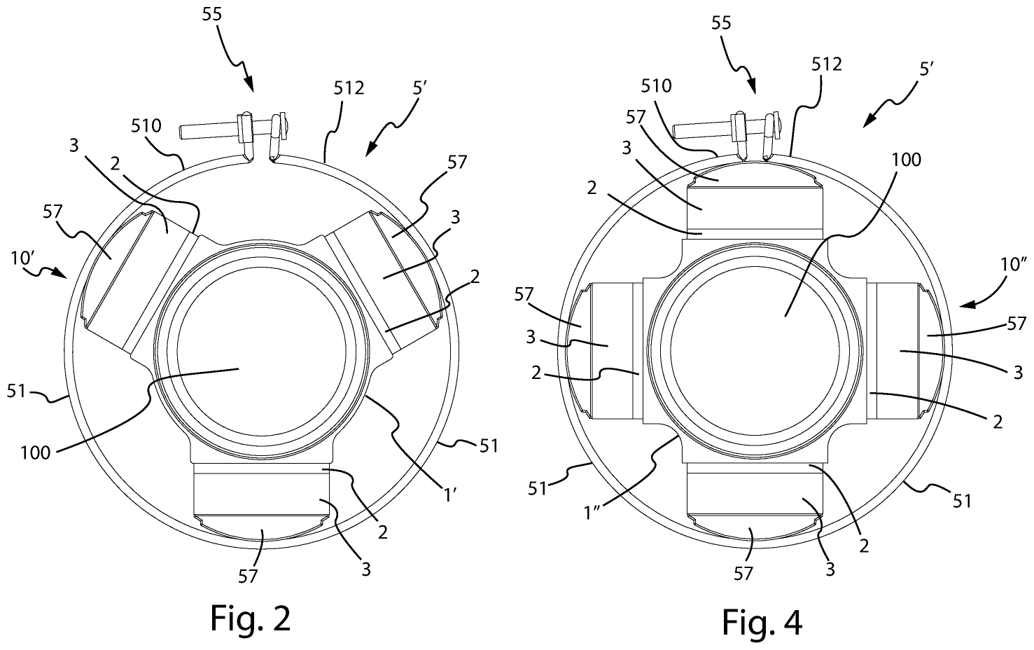

As for example in FIGS. 1, 2, the system 10′ can comprise three or more Peltier cells 2 arranged laterally to the central body 1′, 1″, 1^{III} and directly contacting the central body 1′, 1″, 1^{III} itself.

Preferably, each Peltier cell 2 has an overall flat shape so as to form two greater faces each of which facing a direction of the space substantially opposite to that the other plate faces.

For this purpose, each Peltier cell 2 can have a substantially plate shape, preferably flat (FIGS. 1-6).

Preferably, the Peltier cells 2 are arranged so as to have one of the greater faces contacting the central body 1′, 1″, 1^{III}, so as to promote the heat transmission to and from the body 1′.

For this purpose, the central body 1′, 1″, 1^{III} preferably forms one or more coupling faces 11 configured for coupling with a respective greater face of a Peltier cell 2, particularly with the cold face of such cell; for this purpose, each coupling face 11 can have a substantially flat shape, or otherwise substantially complementary to—or having the cast of—the greater face of the Peltier cell 2.

The one or more coupling faces 11 is preferably formed on the external flanks of the central body 1′, 1″, 1^{III} (FIG. 9).

The cooling system 10′ preferably comprises one or more heat sinks 3 for example in a number corresponding to the number of Peltier cells 2 and suitable for keeping the temperature of the same under control during the steps of cooling the food mixture.

The cooling system 10′ can comprise a variable number of Peltier cells 2 depending on the requirements, therefore on the required cooling power, which can be arranged both laterally to and below the central body 1′, 1″, 1^{III}.

According to an aspect of the present invention, the cooling system 10′ comprises at least three Peltier cells 2 and accordingly a corresponding number of heat sinks 3 associated to each Peltier cell (FIGS. 1, 2).

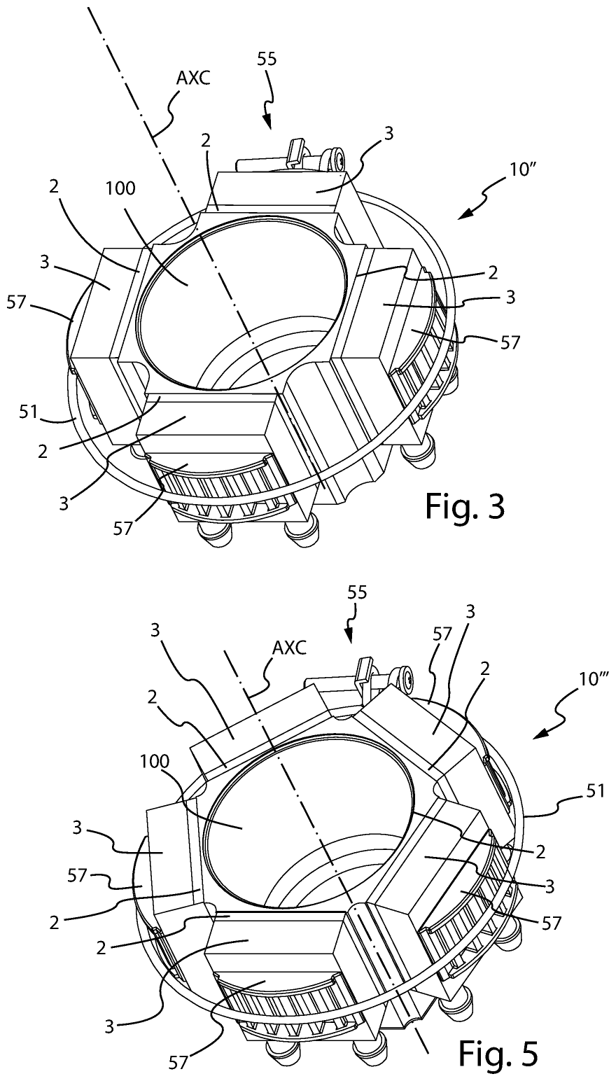

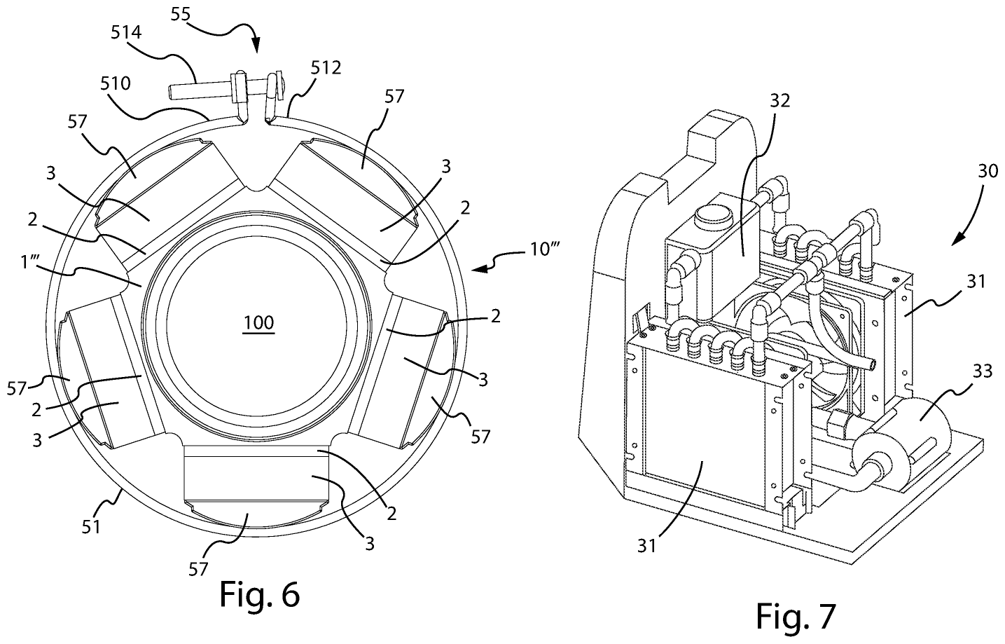

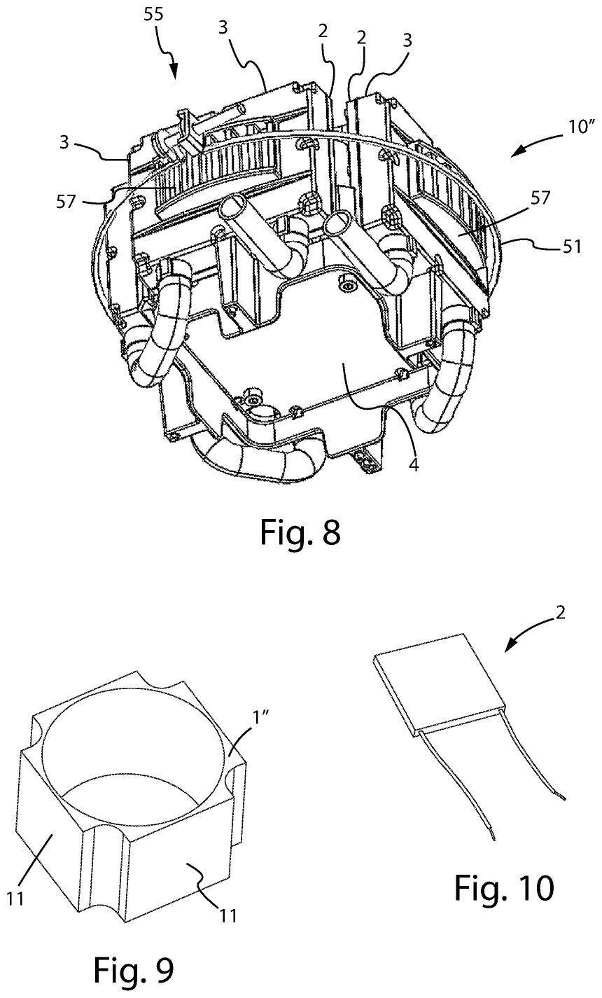

The cooling system 10′ can possibly comprise even at least four Peltier cells 2 (FIGS. 3, 4), at least five Peltier cells 2 (FIGS. 5, 6), at least six Peltier cells 2, at least seven Peltier cells 2, at least eight Peltier cells 2, and for example three, four, five, six, seven, eight, nine, ten, or more Peltier cells 2 each of which arranged for example on the external flanks of the central body 1′, 1″, 1^{III}.

The cooling system 10′ further comprises an assembling system 5′ which keeps the central body 1′, 1″, 1^{III}, the three or more Peltier cells 2 and the corresponding three or more cooling subunits 3 assembled.

According to an aspect of the invention the assembling system 5′ in turn comprises a belt element 51 and a tensioner 55.

The belt element 51 extends around the at least three Peltier cells 2 and the relative heat sinks 3.

The tensioner 55 is configured for tensioning the belt element 51 by reducing or tending to reduce the perimeter of the portion of the belt element 51 extending around the at least three Peltier cells 2 and the one or more possible heat sinks 3 so as to tighten the at least three Peltier cells 2 against the external flanks of the central body 1′, 1″, 1^{III} and fix the at least three Peltier cells 2 to said external flanks.

For this purpose, the tensioner 55 is configured for tensioning the belt element 51 so as to approach or tend to approach each other at least two proximity sections 510, 512 of the belt element 51—for example two single proximity sections 510, 512—adjacent to the tensioner 55—for example the closest to the tensioner 55—so as to tighten the at least three Peltier cells 2 against the external flanks of the central body 1′, 1″, 1^{III} and fix the at least three Peltier cells 2 to said external flanks.

The belt element 51 can comprise for example a wire (FIGS. 1-6), a band or strip, a chain, a membrane, a coil spring; preferably, such elements can be made for example of steel or other metallic material but can be also made of a synthetic resin or other non-metallic materials.

Making the belt element 51 of metallic material, especially if in the form of a metallic wire, facilitates its sliding on the mechanical adapters 57 while the element 51 is tightened around them, or otherwise tensioned.

The belt element 51 is preferably coated by a layer of anti-corrosion material.

The tensioner 55 can comprise for example a screw drive configured for approaching each other the two proximity sections 510, 512 of the belt element 51, for example by pulling or pushing the two proximity sections 510, 512 so as to slide them in directions substantially parallel or longitudinal to the sections 510, 512 themselves by reducing the perimeter of the belt element 51.

For this purpose, the tensioner 55 can comprise for example a screw 514 configured for screwing and unscrewing in a nut screw by rotating around an axis substantially parallel or longitudinal to the two proximity sections 510, 512 (FIGS. 1, 3, 5).

Alternatively, the tensioner 55 can comprise for example a cam, lever, or inclined plane system and be driven thereby.

Possibly, the screw 514 or other screw or a screw, cam, lever, or inclined plane drive of the tensioner 55 can be configured for tensioning the belt element 51 by reducing or tending to reduce the perimeter of the portion of the belt element 51 extending around the at least three Peltier cells 2 and the one or more possible heat sinks 3 so as to tighten the at least three Peltier cells 2 against the external flanks of the central body 1′, 1″, 1^{III} and fix the at least three Peltier cells 2 to said external flanks.

Possibly, a single screw 514 or another single screw, a single screw drive, a single cam, a single lever, or a single inclined plane can be configured for tensioning the belt element 51 by reducing or tending to reduce the perimeter of the portion of the belt element 51 extending around the at least three Peltier cells 2 and the one or more possible heat sinks 3 so as to tighten the at least three Peltier cells 2 against the external flanks of the central body 1′, 1″, 1^{III} and fix the at least three Peltier cells 2 to said external flanks.

Preferably, the assembling system 5′ comprises a single belt element 51 and/or a single tensioner 55.

Preferably, each tensioner 55 is configured for tensioning a single belt element 51 so as to reduce or tend to reduce the perimeter of the portion of the belt element 51 extending around all the three of the at least three Peltier cells 2 and the one or more possible heat sinks 3, by tightening the at least three Peltier cells 2 against the external flanks of the central body 1′, 1″, 1^{III} and fixing the at least three Peltier cells 2 to said external flanks.

Advantageously, the assembling system 5′ further comprises one or more mechanical adapters 57 each of which is interposed between the belt element 51 and one or more heat sinks 3 or otherwise one or more Peltier cells 2 so as to transmit to such cells 2 and possibly to the sinks 3 the thrust applied by the belt element 51 towards the working cavity 100 and/or towards the centre of the central body 1′, 1″, 1^{III}.

Each mechanical adapter 57 can be made for example like a bearing or pad preferably made of a relatively rigid and slick material such as for example polyoxymethylene (POM or acetal resin), polyamide (PA), or polytetrafluoroethylene (Teflon®) so as to reduce the friction with the belt element 51.

A reduced friction between the mechanical adapters 57 and the belt element 51 makes the tangential forces applied by the latter to the adapters 57 when it is tightened—o otherwise tensioned—and accordingly applied by the adapters 57 to the Peltier cells 2 negligible, improving the adherence and the contact of the adapters against the cells 2 and therefore the performance of the latter.

Still in order to reduce the friction between the belt element 51 and the mechanical adapters 57, each of them preferably forms one or more ribs, corrugations, studs or other protrusions 570 on its face—or other surface—which rests against the belt element 51 or in any case faces it so as to reduce the surface contacting the belt element 51 (FIGS. 1, 3, 5).

Indeed, the pressure between the Peltier cells 2 and the central body 1′, 1″, 1^{III} is very important in order to keep the efficiency of the cooling system 10′, 10″, 10^{III} high, while the pressure between the Peltier cells 2 and the heat sinks 3 is very important for the good operation of the Peltier cells 2 themselves, preventing them from overheating.

Preferably, the cooling system 10′, 10″, 10^{III} further comprises a base element 4 made of a thermal insulating material suitable for acting as a base and meanwhile as a mounting mask for the cooling system 10 itself on the machine in which it is used.

Particularly, the heat sinks 3 can be of the liquid type and be fluidically or otherwise functionally connected to a cooling circuit 30, illustrated in FIG. 7, comprising at least a radiator 31, a tank 32, and to a pump 33 for recirculating the cooling liquid and comprise at least an inlet piping and an outlet piping of the cooling liquid preferably made of copper.

As visible in FIGS. 1-6, it consists of heat exchangers having the external shape for example of a block and in which the cooling liquid circulates due to the thrust of the pump 33.

In each heat sink 3 the heat carrier liquid goes in and out through a respective inlet and outlet piping.

Advantageously, the cooling liquid can be water or any other type of cooling liquid.

FIG. 7 illustrates a possible embodiment of the cooling circuit 30 inside a machine.

Furthermore, the Peltier cells 2 can be powered for example at 15 V by an electrical energy source arranged for example in the machine.

Each Peltier cell 2, as illustrated in FIG. 10, preferably comprises a shell of two ceramic plates which sandwich semiconductors which, passed through by direct current, cool one of the two plates and heat the other.

In such case, the ceramic plate facing the central body 1′, 1″, 1^{III} will be cooled, thus cooling the content of the central body 1′, 1″, 1^{III} itself, while the ceramic plate facing the opposite side will be heated in a controlled manner due to the heat sinks 3 associated to each Peltier cell 2.

Possibly, by inverting the polarity of the electrical power of the Peltier cells 2, these can be used to heat the ceramic plate facing the central body 1′, 1″, 1^{III}, thus heating the content of the central body 1′, 1″, 1^{III} itself, and instead cooling the ceramic plate facing the opposite side; in such case the heat sinks 3 are preferably deactivated, if they are active and not only passive components.

Still preferably, the base element 2 is made of synthetic resin.

The operation of the cooling system is as follows.

The mixture of ingredients to be cooled is inserted into the working cavity 100 and the machine, particularly its cooling system 10′, 10″, 10^{III}, are activated.

Therefore, the semiconductors present in the Peltier cells 2 are passed through by a direct current, provided by the power supply present in the machine, which causes a side of them to be cooled, particularly that contacting the central body 1′, 1″, 1^{III}, and the opposite side to be heated.

Meanwhile, the heat sinks 3 are activated, which due to the cooling circuit 30 are passed through by a cooling liquid suitable for keeping the temperature of the side of the Peltier cells 2 facing them under control.

Such system allows to obtain the freezing of the mixture inside the central body in about 180 seconds.

The features and advantages of the system being the object of the present invention are apparent from the preceding description; particularly, it is apparent that the same the belt element 51, the same tensioner 55 and the same mechanical adapters 57 can be mounted without needing any modification in cooling systems 10′, 10″, 10^{III} provided with a different number of Peltier cells 2; this allows to remarkably standardize the required components to produce a wide range of cooling systems, to reduce the number of such components and their production costs due to the greater scale economies.

Reducing the production costs is also facilitated by the attitude of the belt element 51 and the tensioner 55 to be made with extremely simple shapes and mechanisms.

It is clear, finally, that the system thus conceived is susceptible of a number of modifications and variations without departing from the scope of the present invention; for example, each wire, band, strip, chain, or membrane pertaining to the belt element 51 and for example forming it can be wound around the at least three Peltier cells 2, so as to tighten them, forming one or more turns.

Furthermore, all the details are replaceable by technically equivalent elements.

In practice, the used materials, as well as the size, can be any depending on the technical requirements.

1. A cooling system for a machine for processing a mixture, comprising:
a central body configured to house at least one of the mixture and a product to be cooled and which forms external flanks;
at least three Peltier cells each of which rests on the external flanks of the central body;
at least one heat sink configured to regulate a temperature of at least one of the Peltier cells; and
an assembling system comprising a belt element and a tensioner;
wherein:
the belt element extends around the Peltier cells and the heat sink; and
the tensioner is configured to tension the belt element to reduce or maintain a perimeter of a portion of the belt element extending around the Peltier cells and the heat sink to tighten or fix the Peltier cells against the external flanks of the central body.

2. The cooling system according to claim 1, wherein the tensioner is configured to tension the belt element to reduce or maintain a distance between at least two proximal sections of the belt element adjacent to the tensioner to tighten or fix the Peltier cells against the external flanks of the central body.

3. The cooling system according to claim 1, wherein the tensioner is configured to reduce a distance between at least two proximal sections of the belt element adjacent to the tensioner by causing the proximal sections to slide in directions substantially parallel or longitudinal to the sections themselves, or maintain the reduced distance.

4. The cooling system according to claim 1, wherein:
the belt element comprises at least one element selected from the group consisting of a wire, a band or strip, a chain, and a membrane; and
the element comprises a metallic material.

5. The cooling system according to claim 4, wherein:
the belt element comprises a single element selected from the group consisting of a wire, a band or strip, a chain, and a membrane;
the element comprises a metallic material; and
the element is configured to be tensioned by the tensioner to tighten or fix the Peltier cells against the external flanks of the central body.

6. The cooling system according to claim 5, wherein:
the belt element comprises a single element selected from the group consisting of a wire, a band or strip, a chain, and a membrane;
the element comprises a metallic material; and
the element is configured to be tensioned by the tensioner to tighten or fix the Peltier cells against the external flanks of the central body.

7. The cooling system according to claim 1, comprising at least four Peltier cells.

8. The cooling system according to one claim 1, comprising at least one mechanical adapter, each such adapter being interposed between the belt element and at least one corresponding Peltier cell so as to transmit to the cell the force applied by the belt element towards a working cavity and/or a center of the central body.

9. The cooling system according to claim 8, wherein:
the at least one mechanical adapter is softer and/or more compliant than the corresponding Peltier cell so as to make pressure applied by the belt element more uniform in space and more constant over time on the Peltier cell and on the at least one heat sink by fixing more firmly and stably the Peltier cell and the heat sink to the flanks of the central body.

10. The cooling system according to claim 8, wherein:
the at least one mechanical adapter comprises at least one selected form the group consisting of ribs, ridges, corrugations, studs, and other protrusions on a surface that rests against and or faces the belt element to promote sliding between the belt element and the mechanical adapter.

11. The cooling system according to claim 1, wherein the tensioner comprises at least one selected from the group consisting of a screw, a cam, an inclined plane, and a lever drive configured to reduce or maintain a distance between two proximal sections of the belt by pulling or pushing the proximal sections.

12. The cooling system according to claim 8, wherein at least one of the mechanical adapters comprises a synthetic resin.

13. A machine for producing ice cream, comprising the cooling system according to claim 1.
